(19) United States
(12) Patent Application Publication
(10) Pub. No.: US 2024/0381082 A1
(43) Pub. Date: Nov. 14, 2024

(54) ENHANCING SECURITY AGAINST FALSE BASE STATIONS

(71) Applicant: Lenovo (Singapore) Pte. Ltd., New Tech Park (SG)

(72) Inventors: Prateek Basu Mallick, Dreieich (DE); Joachim Löhr, Wiesbaden (DE); Andreas Kunz, Ladenburg (DE); Ravi Kuchibhotla, Chicago, IL (US); Hyung-Nam Choi, Ottobrunn (DE)

(21) Appl. No.: 18/692,713

(22) PCT Filed: Sep. 14, 2022
(86) PCT No.: PCT/IB2022/058673

§ 371 Date: Mar. 15, 2024

Related U.S. Application Data
(60) Provisional application No. 63/244,629, filed on Sep. 15, 2021.

(51) Int. Cl. H04W 12/06; H04W 68/00

(52) U.S. Cl. CPC H04W 12/06; H04W 68/00

(57) ABSTRACT

Apparatuses, methods, and systems are disclosed for enhancing security against false base stations. An apparatus (700) includes a transceiver (725) and a processor (705) that is coupled to the transceiver (725). The processor (705) is configured to cause the apparatus (700) to connect to a base station of a mobile wireless communication network, verify an authenticity of the connected base station while in an inactive state, and disconnect from the connected base station in response to the authenticity of the connected base station failing.

### CROSS REFERENCE TO RELATED APPLICATIONS

This application claims the benefit of U.S. Provisional Patent Application No. 63/244,629, entitled “ENHANCING SECURITY AGAINST FALSE BASE STATIONS” and filed on Sep. 15, 2021, for Prateek Basu Mallick, et al., which is incorporated herein by reference.

### FIELD

The subject matter disclosed herein relates generally to wireless communications and more particularly relates to enhancing security against false base stations.

### BACKGROUND

In wireless networks, base stations provide a mobile device, such as a user equipment (“UE”) device, access to a mobile network. Fake or false base stations may be used to deny services to a UE, attack a UE, provide rogue services to a UE, and/or the like.

### BRIEF SUMMARY

In one embodiment, a first apparatus includes a transceiver and a processor that is coupled to the transceiver. In one embodiment, the processor is configured to cause the apparatus to connect to a base station of a mobile wireless communication network, verify an authenticity of the connected base station while in an inactive state, and disconnect from the connected base station in response to the authenticity of the connected base station failing.

In one embodiment, a first method connects to a base station of a mobile wireless communication network, verifies an authenticity of the connected base station while in an inactive state, and disconnects from the connected base station in response to the authenticity of the connected base station failing.

In one embodiment, a second apparatus includes a transceiver and a processor that is coupled to the transceiver. In one embodiment, the processor is configured to cause the apparatus to determine a set of time occasions for transmission of a secret paging message to a UE, the secret paging message for verifying an authenticity of a base station, transmit, to the UE, an indication of the set of time occasions for transmission of the secret paging message, and trigger transmission of the secret paging message to the UE during a time occasion of the set of time occasions.

In one embodiment, a second method determines a set of time occasions for transmission of a secret paging message to a UE, the secret paging message for verifying an authenticity of a base station, transmits, to the UE, an indication of the set of time occasions for transmission of the secret paging message, and triggers transmission of the secret paging message to the UE during a time occasion of the set of time occasions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for enhancing security against false base stations;

FIG. 2 shows a general diagram of the radio coverage of a genuine base station where a UE is camped on (in radio resource control (“RRC”) Idle or Inactive state) or connected to (in RRC Connected state) a fake base station;

FIG. 3 shows a procedure for sending a secret paging occasion (“s-PO”) configuration to a UE in a secure session and receiving a secret paging (“s-paging”);

FIG. 4 shows a procedure for sending an s-PO configuration to a UE in a secure session and not receiving an s-paging;

FIG. 5 shows a procedure for sending an s-PO configuration to a UE in a secure session using a secret service temporary mobile subscriber identity (“S-TMSI”) instead of an s-paging;

FIG. 6 is a diagram illustrating one embodiment of a NR protocol stack;

FIG. 7 is a block diagram illustrating one embodiment of a user equipment apparatus that may be used for enhancing security against false base stations;

FIG. 8 is a block diagram illustrating one embodiment of a network apparatus that may be used for enhancing security against false base stations;

FIG. 9 is a flowchart diagram illustrating one embodiment of a method for enhancing security against false base stations; and

FIG. 10 is a flowchart diagram illustrating one embodiment of a method for enhancing security against false base stations.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of' includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the FIGURES illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for enhancing security against false base stations. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A fake (false) base station (“FBS”) may be a cause of various problems in a mobile network, such as:
1. Denial of Service (“DoS”) attack on the UE, which attempts to hinder the UE's access to the network.
2. DoS attack on network, which attempts to hinder the network's ability to provide services to the UE.
3. Rogue services, which attempt to deliver unauthorized or unsolicited services (e.g., SMS and calls) to the UE.
4. Subscriber privacy attack, which attempts to identify subscriptions or trace the UE.

In one embodiment, to get rid of an FBS, an RRC Idle or Inactive state UE first needs to detect that it is camped on an FBS. This subject matter herein discloses means to achieve this and further provides means to get rid of an FBS.

This disclosure first describes methods by which the UE can first suspect that it is served by an FBS and then go on to determine if it is really served by the FBS. An interesting concept of secret paging, among other solutions, is disclosed whereby only the UE and the access and mobility management function (“AMF”) knows that the UE needs to be deterministically paged within a certain time window.

In one embodiment the concept of secret paging is further improved to tackle increased physical downlink control channel (“PDCCH”) blocking probability. This embodiment uses a secret S-TMSI instead of the s-POs in the third embodiment. In one embodiment, the secret-S-TMSI is provided to the UE using non-access stratum (“NAS”) signaling when (or subsequently after) performing one of the NAS procedures e.g., registration or registration area update procedure. The UE may beforehand or alongside (e.g., in a registration request) indicate its capability to detect an FBS and/or its need to avoid an FBS. In such case, the core network (e.g., AMF) may provide the UE with a secret S-TMSI, which is different from the received S-TMSI. The secret S-TMSI could be allocated as part of an allocated secret-global unique temporary identifier (“GUTI”). In one embodiment, presence of this secret-S-TMSI in the RRC paging message provides an indication that the UE is on a genuine gNB. Here, s-paging is still done in the POs, e.g. . . . , s-POs may not be necessary per se.

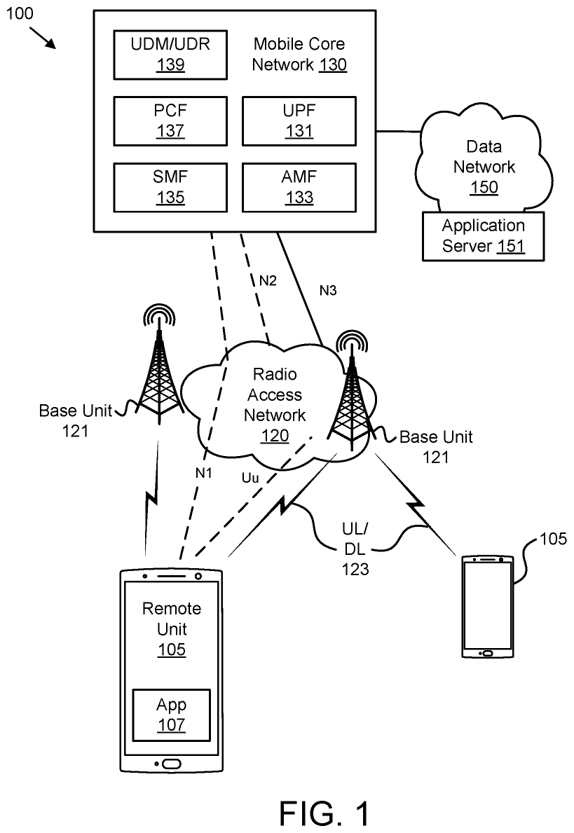

FIG. 1 depicts a wireless communication system 100 supporting enhancing security against false base stations, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

To establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an AMF 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”) 139.

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, Zig Bee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting enhancing security against false base stations.

As background, conventional solutions for resolving issues with FBSs depend on measurement reports sent by UEs to the network, which already contain various information of the surrounding radio conditions. Those measurement reports could be further enriched so that the detection of FBSs becomes more effective. Further, different types of measurement reports could be considered, e.g., logged measurement reports. In one embodiment, connection of the UE to the FBS could be avoided during handover. However, none of the conventional solutions dictate how an RRC Idle/Inactive UE detects that it is (or might be) under the coverage of FBS.

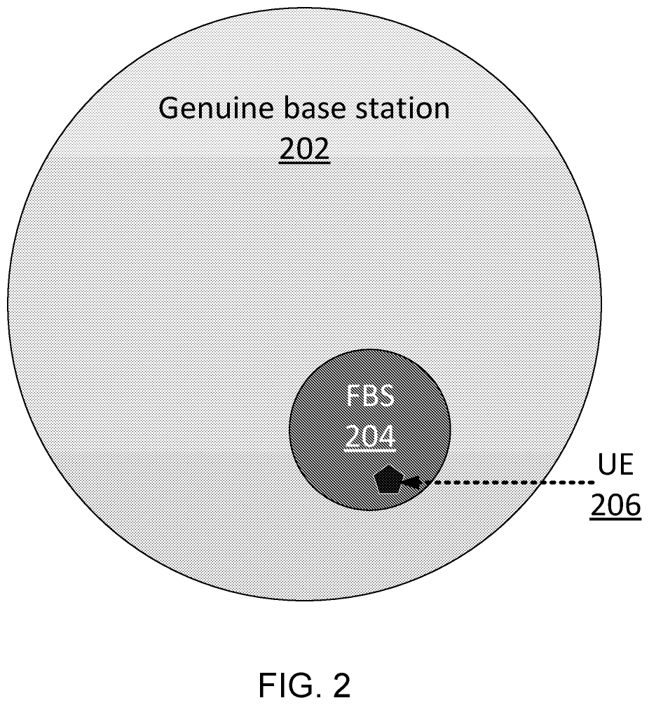

FIG. 2 shows a general diagram of the radio coverage of a genuine BS 202 where a UE 206 is camped, in RRC Idle or Inactive state, or connected to, in RRC Connected state, an FBS 204 supposing that it is on the genuine BS 202. The UE's 206 trust comes by virtue of absence of suspicion that the UE 206 may be on an FBS 204. Various embodiments described herein help the UE 206 determine if it is on an FBS 204. Though the determinations in the following embodiments are principally written for a UE 206 in RRC Idle or Inactive state, these are equally applicable for an RRC Connected UE 206 that may have slipped in to an FBS 204 area and has not since received any communication from the base station. As used herein, an FBS 204 is defined as a radio base station that can replay some or all broadcast messages including synchronization codes publishing a cell identity, master information block (“MIB”), system information block 1 (“SIB1”), or the like. An FBS 204 may or may not have the capability to reproduce every single common DL message (like Paging) or dedicated DL message in a timely manner (real-time or almost in real-time).

In a first embodiment, a UE implementation is disclosed where a UE from time to time e.g., using a timer of, for example, 100 seconds, determines if it is camped on a genuine base station. In a variation of this embodiment, the necessity to verify authenticity of camped base station may also be configured by the network e.g., as part of the UE's registration, an AMF may configure the UE to periodically verify e.g., using a configured timer that its camped base station is genuine.

In yet another variation, instead of periodic timer or in addition to the timer, some events can be defined and configured by the network (core network or a genuine radio network when such configuration is sent protected using RRC Connected Security keys). The events could be defined around a sudden change of radio condition e.g., when the UE would rather expect deteriorating reference signal received power (“RSRP”) (when moving from cell centre to cell edge) but suddenly it measures an ‘x’ dB increase in the base station's signal power resulting in a ‘V’ curve for signal (e.g., SSB) measurements. The UE may conclude the cell as an FBS only if the physical cell ID (“PCI”) and CellIdentity, as broadcasted in SIB1 of the cell, has not changed before and after the sudden change of radio quality. The UE stores PCI and CellIdentity information and verifies, when a ‘V’ curve for signal (e.g., SSB) measurements occurs if the PCI and CellIdentity remain the same, after acquiring these afresh. If yes, the UE concludes that it is on an FBS; otherwise, the UE does not take any new action since it is on a new genuine cell. Accordingly, the first embodiment enables the UE to suspect the camped base station.

In a second embodiment, a suspecting UE can verify its serving gNB by attempting to go to RRC Connected state and doing a normal bi-directional authentication. In one embodiment, the UE determines that it is camped on an FBS if one of more of the following occurs:
If the attempts fail continuously for a certain number of times especially in good geometry (e.g., RSRP of the camped cell above a certain threshold), e.g., due to:
   1. Random Access failures: or
   2. Timer T300 (or T301 or T319) runs out:
Or, if the UE receives RRCReject multiple times with or without longer wait time T302);
Or, the UE experiences a stalled flow at some stage, e.g., after sending RRCSetupComplete it receives no other DL message for a while.

In a third embodiment, a concept of s-paging is disclosed. s-paging is done by the network (e.g., AMF, gNB) at s-POs that are either:
not calculable, e.g., as in 3GPP TS 38.304 (i.e., not based on UE_ID and paging parameters). In such an embodiment, the AMF informs the UE directly in a protected NAS message on the time occasions for transmitting s-paging. This could be done in a variety of ways e.g., by telling the UE to monitor paging on a first subframe of subframe number (“SFN”) mod 100 =0; or, by setting an offset relative to the paging occasions, e.g., as calculated in TS 38.300. The s-POs provided by the AMF to the UE may be a list of POs and may be refreshed once the AMF recognizes the last POs of the list are approaching.
calculable using a formula, e.g., from 3GPP TS 38.304, but using a different value for any of the input parameters, e.g., UE_ID or any other parameters described in clause 7.1 of 3GPP TS 38.304. The parameter and/or its value is signaled to the UE by the network in a protected NAS message.

In one embodiment, the s-paging is done “deterministically,” e.g., there's a guarantee that UE shall be s-paged by a genuine network. The guarantee may stand for every s-paging occasion or in a time window. In the latter case, the UE knows that the next s-paging must be received within certain time after receiving an s-paging. The time window could be absolute, e.g., in seconds or in a number of the UE's discontinuous reception (“DRX”) cycles. The time window concept makes it further difficult for an observer to trace occurrences of PagingRecord/ue-Identity (e.g., as defined in 3GPP TS 38.331) since the network can randomize such occurrences.

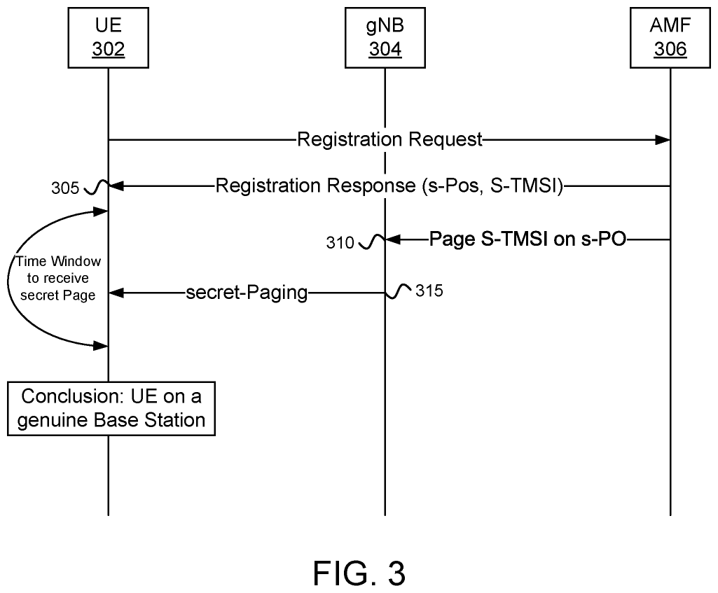

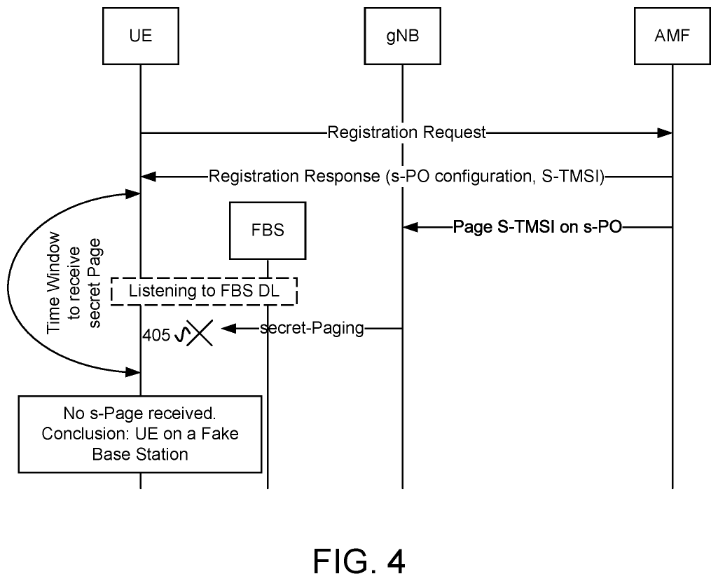

As shown in FIG. 3, an s-paging configuration (s-POs directly or factors leading to calculation of s-POs) is sent (see messaging 305) to UE 302 in a secured session e.g., after UE 302 is registered and security is active. When the AMF 306 decides to secretly page the UE 302, it provides (see messaging 310) the POs (or time window) to the gNB 304 that may be used to send the paging message to the UE 302. In this case, gNB 304 does not need to calculate the POs of the UE 302, e.g., as described in 3GPP TS 38.304, but rather follow the instruction of the AMF 306 and include the S-TMSI as a PagingRecord inside an RRC Paging message (see messaging 315). For conveying the s-POs, as an example, the AMF 306 may have configured the UE 302 to monitor secret paging in the first 5 ms. at the start of every 100 ms., where the time starts at the SFN#0, subframe#0of the serving gNB 304, or the like. So, in this example, 5 ms. occurring periodically every 100 ms. refer to the POs. The s-PO configuration may also include a time window where the UE 302 is guaranteed to receive at least one s-Page. Extending the example, if the time window is 10 seconds, then the UE 302 receives an s-Page at least once in any of the s-POs. The UE 302 need not respond to s-paging
if the UE 302 receives s-paging, it knows that it is on a genuine BS (as in FIG. 3).
if the UE did not receive one or more s-paging, it knows that it is on an FBS (see messaging 405 in FIG. 4).

In one embodiment, the s-paging can be turned off by network in zero-threat areas and can be turned on when/where required. Since it is optional and based on the network/UE's threat perception, the extra paging monitoring should not be a hindrance to implement or use. In an enhancement to this embodiment, optimizations can be achieved where the network uses the s-paging to also page the UE. In one embodiment, the s-paging may lead to a higher PDCCH blocking probability. In a possible network side implementation of this embodiment, some measures (or a combination thereof) can be taken:
RRC measures:
   1. There can be more than one UE paged using the same s-Paging.
   2. Keep the susceptible UEs in RRC_Inactive and configure a smaller number of cells in RAN area (PLMN-RAN-AreaCellList).
   3. Implement Idle mode load balancing.
Physical layer measures:
   1. Increases the number of PDCCH candidates for each AL results in a lower blocking probability.
   2. Increases the number of BDs and control channel element (“CCE”) monitoring (requires higher UE capability).
   3. When suspecting an FBS at a cell center, use lower ALs to get a lower PDCCH blocking probability.
   4. Scheduling strategy of the network (start with the lower ALs).

In another embodiment, the concept of s-paging is further enhanced to tackle increased PDCCH blocking probability. This embodiment uses a secret-S-TMSI instead of the s-POs in the embodiment above. The secret-S-TMSI may be provided to the UE using NAS signaling when (or subsequently after) performing one of the NAS procedures e.g., service request, registration, or registration area update procedure. The UE may beforehand/or alongside (e.g., in a registration request) need to indicate its capability to detect FBS and/or its need to avoid FBS. In such case, the CN (e.g., AMF) may provide the UE with a secret-S-TMSI which is different from the received S-TMSI. The secret-S-TMSI could be allocated as part of an allocated secret-GUTI.

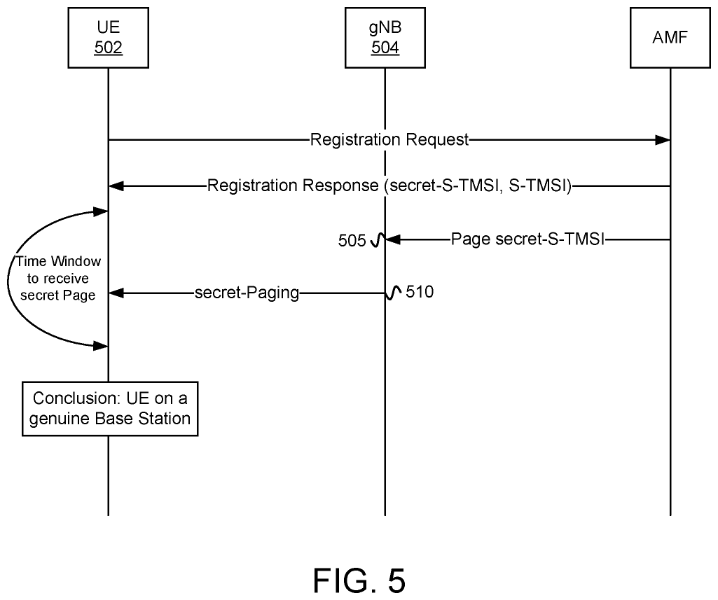

In one embodiment, as shown in FIG. 5, presence of this secret-S-TMSI in the RRC paging message (see messaging 505, 510) provides an indication that the UE 502 is on a genuine gNB 504. Here, s-Paging is still done in the POs, e.g., the s-POs are not necessary per se, as shown in FIG. 5. This embodiment also has the benefit that the secret paging is transparent to gNB 504 e.g., the gNB 504 need not know that the secret-S-TMSI is any different from any of the other (normal) S-TMSIs. However, one implementation of this embodiment may benefit from the s-POs concept disclosed in the previous embodiment.

In one embodiment, the network only guarantees that there will be a secret-S-TMSI at least once in ‘x’ DRX Cycles (or equivalent ‘y’ seconds) and thereby the network randomizes the presence of the secret-S-TMSI in POs to avoid an attacker tracing the presence of possible secret-S-TMSI(s). Since a PagingUE-Identity is 48 bits (NG-5G-S-TMSI) or 40 bits (I-RNTI-Value) long, there's no shortage of such identities. In one embodiment, a secret-S-TMSI or secret-inactive-radio network temporary identifier (“RNTI”)-Value is allocated by the AMF or the gNB respectively using secured e.g., security activated) signaling. There may be more than one UE given the same secret-S-TMSI/secret-I-RNTI-Value. Unlike previously indicated, in one variation for an RRC Inactive UE, the gNB needs to page the UE with s-paging if the AMF has conveyed that a certain UE need be paged secretly from time to time. The AMF may independently inform this to the serving gNB of an RRC Connected UE or may inform the gNB when the gNB informs the AMF that a certain UE is transitioning to RRC Inactive state.

In another variation, the normal S-TMSI is used but changed for each of the s-POs, e.g., the S-TMSI is concatenated with a shared secret value in the UE and the AMF, e.g., subscription concealed identifier (“SUCI”), subscription permanent identifier (“SUPI”), K_{amf}, K_{nas-enc}, Kₙₐₛ₋ᵢₙₜ, UL NAS COUNT, DL NAS COUNT, and/or the like, and then the combined string is hashed with a hash function, e.g., SHA-256 and truncated at the most or least significant bits e.g., to 40 bits or 48 bits. The truncated value may then be used for the next PO as a secret S-TMSI.

In another embodiment, the concept of secret paging as in the previous embodiments is used, but instead of secret-S-TMSI, it uses an s-RNTI for s-Paging. This still contributes to higher PDCCH blocking rate and the network side solutions described previously needs to be used.

According to another embodiment, the UE is assigned a secret paging group that is only known to the UE and network entities, such as the AMF or a genuine base station. In one embodiment, RAN2 discussed UE paging based on subgrouping as part of the Rel-17 work on UE power saving enhancement to reduce power consumption in the UE due to false paging alarms. This is done by further dividing the UEs within a paging occasion into multiple subgroups.

There are two subgrouping approaches, in one embodiment, namely CN-assigned subgrouping and UEID-based subgrouping. For the CN-assigned subgrouping, the CN (e.g., AMF) assigns the subgroup ID. According to this embodiment, the AMF assigns a secret subgroup ID to a UE e.g., this subgroup may be signaled in addition to the “normal” subgroup identity. When the AMF has assigned a UE with a secret Paging subgroup, some protected NAS signaling message should be supported between the AMF and the UE to convey the related information to the UE. Also, some protected signaling between the AMF and the gNB(s) is introduced to inform the gNB(s) about the secret paging subgroup. According to one implementation of the embodiment, the secret paging subgroup could be used to indicate to a UE that the base station is a genuine base station if the UE is deterministically paged at least once in a configured time window. As already outlined in other embodiments, the UE need not respond to the paging on the secret paging subgroup. In one specific implementation, the UE reads the paging downlink control information (“DCI”) to verify a genuine base station:
if the UE receives paging on an s-paging subgroup, it knows that it is on a genuine BS
if the UE did not receive one or more paging on an s-paging subgroup within a certain time window, e.g., not once in ‘x’ occurrences of the paging occasions for the secret subgroup, it knows that it is on an FBS

The paging on a secret paging subgroup may be done “deterministically,” e.g., there's a guarantee that the UE will be s-paged by a genuine network. The guarantee may stand for every paging occasion corresponding to the secret aging subgroup or in a time window. In the latter case, the UE knows that the next paging must be received within a certain time after receiving a paging.

In another implementation, the secret paging subgroup is further used to determine an s-paging occasion, which is only known to genuine network entities and the UE.

A driving point for another embodiment is to make the FBS process the DL e.g., by making it difficult for it to perform a simple replay. This can be done by overlaying a genuine gNB (as shown in FIG. 2) by broadcasting a 1-bit flag when it suspects an FBS presence. The suspicion of a presence of an FBS can be based on:
gNB could depend on the network data analytics function (“NWDAF”) for this;
gNB could get logged measurement reports from UEs;
gNB may use its own reference UEs.

If the FBS just replays everything, it will also make aware the UEs connecting to/camping on it that there may be an FBS and the UEs can then first verify the authenticity of the current gNB by establishing RRC Connection and subsequently security procedure. When failing, UEs move away (to another frequency) and perform security procedure. Since this will potentially impact many UEs, including those served by the genuine cell, a more phased manner of RRC Connection establishment can be used e.g., by using/configuring different sets of access identities/access categories for this purpose.

In another embodiment, a network uses more than one of the solutions disclosed herein. This has the following benefits:
it makes it further difficult for the FBS to perform DoS and other mentioned attacks;
it minimizes overhead like PDCCH or s-TMSI;
it helps in keeping a decent PDCCH blocking probability;
it enables keeping a decent UE power consumption and complexity.

In this embodiment, the network can choose one of the disclosed techniques on a per UE basis e.g., different UEs across the cell are configured to use different FBS detection technique.

Unlike previous embodiments, an embodiment discloses a remedy that can be applied as soon as the UE determines that UE is on an FBS. Upon such detection UE releases RRC connection (if RRC Connected), moves to RRC Idle and initiates Inter-frequency reselection procedure, and then try to go to RRC Connected (and perform a normal bi-directional authentication). As an enhanced feature, the reselection rules are changed, and the conventional radio based reselections do not apply in such a case. Instead, as the first possibility, the UE considers the current cell/frequency as barred for at least a predetermined/preconfigured time. As a second possibility, the UE considers the current frequency to be of lowest absolute frequency priority. As another possibility, the radio condition of this frequency is deemed as lowest, triggering reselection to any other lower/higher priority frequency, irrespective of actual measurement values of the said frequency. After having reselected successfully to another frequency/cell and having established a secured (RRC Connection) connection, a new Report-FBS-and-Authentication procedure can be designed, whereby the UE shares details of the FBS (e.g., physical location, frequency, cell Id, measurement values, or the like).

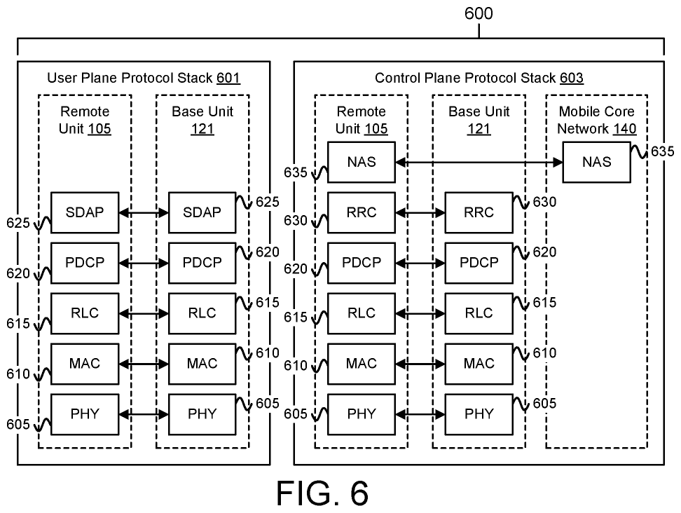

FIG. 6 depicts a NR protocol stack 600, according to embodiments of the disclosure. While FIG. 6 shows the remote unit 105, the base unit 121 and the mobile core network 130, these are representative of a set of UEs interacting with a RAN node and a NF (e.g., AMF) in a core network. As depicted, the protocol stack 600 comprises a User Plane protocol stack 605 and a Control Plane protocol stack 610. The User Plane protocol stack 605 includes a physical (“PHY”) layer 615, a Medium Access Control (“MAC”) sublayer 620, a Radio Link Control (“RLC”) sublayer 625, a Packet Data Convergence Protocol (“PDCP”) sublayer 630, and Service Data Adaptation Protocol (“SDAP”) sublayer 635. The Control Plane protocol stack 610 also includes a physical layer 615, a MAC sublayer 620, a RLC sublayer 625, and a PDCP sublayer 630. The Control Place protocol stack 610 also includes a Radio Resource Control (“RRC”) sublayer and a Non-Access Stratum (“NAS”) sublayer 645.

The AS protocol stack for the Control Plane protocol stack 610 consists of at least RRC, PDCP, RLC and MAC sublayers, and the physical layer. The AS protocol stack for the User Plane protocol stack 605 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 640 and the NAS sublayer 645 for the control plane and includes, e.g., an Internet Protocol (“IP”) layer or PDU Layer (note depicted) for the user plane. L1and L2 are referred to as “lower layers” such as PUCCH/PUSCH or MAC CE, while L3and above (e.g., transport layer, application layer) are referred to as “higher layers” or “upper layers” such as RRC.

The physical layer 615 offers transport channels to the MAC sublayer 620. The MAC sublayer 620 offers logical channels to the RLC sublayer 625. The RLC sublayer 625 offers RLC channels to the PDCP sublayer 630. The PDCP sublayer 630 offers radio bearers to the SDAP sublayer 635 and/or RRC sublayer 640. The SDAP sublayer 635 offers QoS flows to the mobile core network 130 (e.g., 5GC). The RRC sublayer 640 provides for the addition, modification, and release of Carrier Aggregation and/or Dual Connectivity. The RRC sublayer 640 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

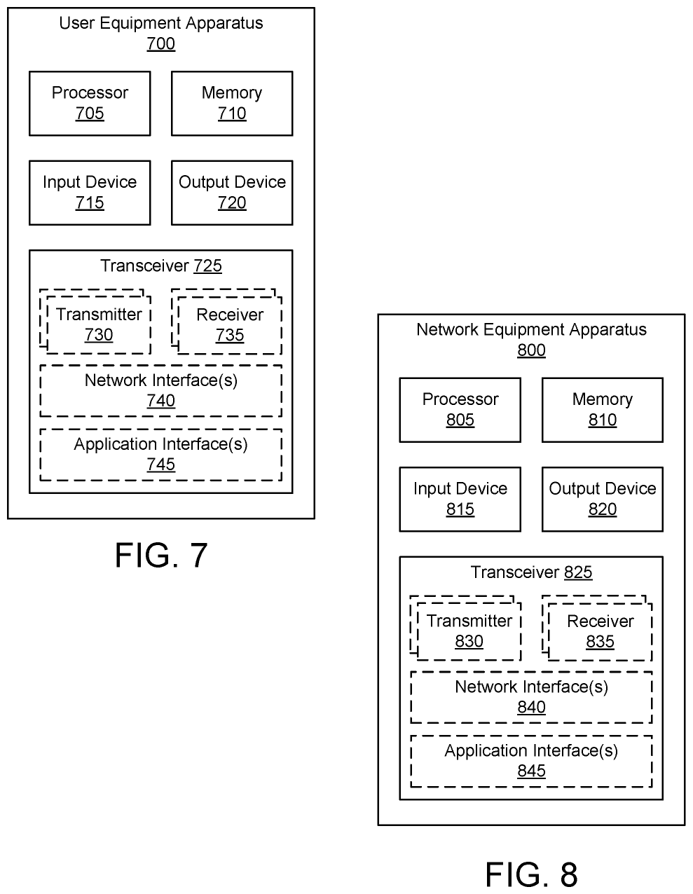

FIG. 7 depicts a user equipment apparatus 700 that may be used for enhancing security against false base stations, according to embodiments of the disclosure. In various embodiments, the user equipment apparatus 700 is used to implement one or more of the solutions described above. The user equipment apparatus 700 may be one embodiment of a UE, such as the remote unit 105 and/or the UE 205, as described above. Furthermore, the user equipment apparatus 700 may include a processor 705, a memory 710, an input device 715, an output device 720, and a transceiver 725. In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more base units 121. Additionally, the transceiver 725 may support at least one network interface 740 and/or application interface 745. The application interface(s) 745 may support one or more APIs. The network interface(s) 740 may support 3GPP reference points, such as Uu and PC5. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to CSI enhancements for higher frequencies. For example, the memory 710 may store parameters, configurations, resource assignments, policies, and the like as described above. In certain embodiments, the memory 710 also stores program code and related data, such as an operating system or other controller algorithms operating on the user equipment apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. The transceiver 725 may be used to provide UL communication signals to a base unit 121 and to receive DL communication signals from the base unit 121, as described herein. Similarly, the transceiver 725 may be used to transmit and receive SL signals (e.g., V2X communication), as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an ASIC, or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

In one embodiment, the processor 705 is configured to connect to a base station of a mobile wireless communication network, verify an authenticity of the connected base station while in an inactive state, and disconnect from the connected base station in response to the authenticity of the connected base station failing.

In one embodiment, the processor 705 is configured to monitor for a secret paging message from the connected base station, during an occasion, to verify the authenticity of the connected base station.

In one embodiment, the processor 705 is configured to receive an indication of the occasion in a protected NAS message.

In one embodiment, the processor 705 is configured to monitor paging, based on the protected NAS message, at an offset relative to a paging occasion.

In one embodiment, the occasion comprises an absolute time, or a number of discontinuous reception cycles, or some combination thereof.

In one embodiment, the processor 705 is configured to cease monitoring for the secret paging message in response to the apparatus being within an area with a threat level that satisfies a threat level threshold.

In one embodiment, the processor 705 is configured to receive standard paging messages from the connected base station using the secret paging message.

In one embodiment, the processor 705 is configured to receive a secret S-TMSI from a network entity for verifying the authenticity of the connected base station.

In one embodiment, the processor 705 is configured to monitor for the secret S-TMSI in paging messages to verify the authenticity of the connected base station.

In one embodiment, the processor 705 is configured to receive the secret S-TMSI during a paging occasion of the apparatus's regular paging occasions.

In one embodiment, the processor 705 is configured to receive the secret S-TMSI in a protected NAS message at least once within a time window.

In one embodiment, the inactive state is one of an RRC idle state and an RRC inactive state.

FIG. 8 depicts one embodiment of a network apparatus 800 that may be used for enhancing security against false base stations, according to embodiments of the disclosure. In some embodiments, the network apparatus 800 may be one embodiment of a RAN node and its supporting hardware, such as the base unit 121 and/or gNB, described above. Furthermore, network apparatus 800 may include a processor 805, a memory 810, an input device 815, an output device 820, and a transceiver 825. In certain embodiments, the network apparatus 800 does not include any input device 815 and/or output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2, N3, N5, N6 and/or N7interfaces. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, an FPGA, a DSP, a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and OS functions and a baseband processor (also known as “baseband radio processor”) which manages radio function. In various embodiments, the processor 805 controls the network apparatus 800 to implement the above described network entity behaviors (e.g., of the gNB) for enhancing security against false base stations.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data relating to CSI enhancements for higher frequencies. For example, the memory 810 may store parameters, configurations, resource assignments, policies, and the like as described above. In certain embodiments, the memory 810 also stores program code and related data, such as an OS or other controller algorithms operating on the network apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, may include any known electronically controllable display or display device. The output device 820 may be designed to output visual, audible, and/or haptic signals. In some embodiments, the output device 820 includes an electronic display capable of outputting visual data to a user. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, all or portions of the output device 820 may be located near the input device 815.

As discussed above, the transceiver 825 may communicate with one or more remote units and/or with one or more interworking functions that provide access to one or more PLMNs. The transceiver 825 may also communicate with one or more network functions (e.g., in the mobile core network 80). The transceiver 825 operates under the control of the processor 805 to transmit messages, data, and other signals and also to receive messages, data, and other signals. For example, the processor 805 may selectively activate the transceiver (or portions thereof) at particular times in order to send and receive messages.

The transceiver 825 may include one or more transmitters 830 and one or more receivers 835. In certain embodiments, the one or more transmitters 830 and/or the one or more receivers 835 may share transceiver hardware and/or circuitry. For example, the one or more transmitters 830 and/or the one or more receivers 835 may share antenna(s), antenna tuner(s), amplifier(s), filter(s), oscillator(s), mixer(s), modulator/demodulator(s), power supply, and the like. In one embodiment, the transceiver 825 implements multiple logical transceivers using different communication protocols or protocol stacks, while using common physical hardware.

In one embodiment, the processor 805 is configured to determine a set of time occasions for transmission of a secret paging message to a UE, the secret paging message for verifying an authenticity of a base station, transmit an indication of the set of time occasions for transmission of the secret paging message, and trigger transmission of the secret paging message to the UE during a time occasion of the set of time occasions.

In one embodiment, the processor 805 is configured to generate a secret S-TMSI for the UE, the S-TMSI for verifying the authenticity of the base station.

In one embodiment, the processor 805 is configured to transmit a secret paging configuration to the UE during a secured session between the apparatus and the UE, the secret paging configuration indicating the set of time occasions, the secret S-TMSI, or both.

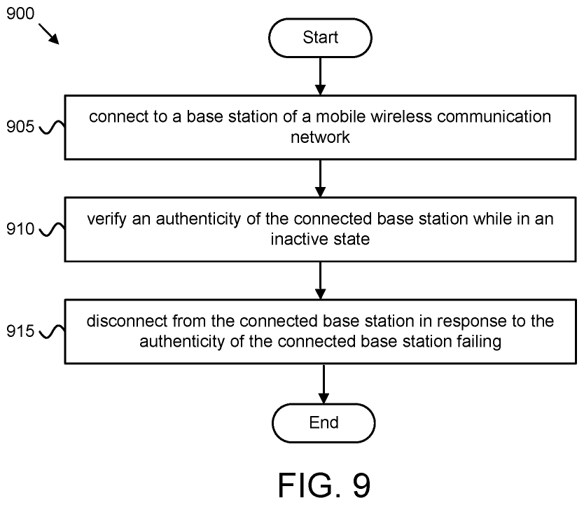

FIG. 9 is a flowchart diagram of a method 900 for enhancing security against false base stations. The method 900 may be performed by a UE as described herein, for example, the remote unit 105 and/or the user equipment apparatus 700. In some embodiments, the method 900 may be performed by a processor executing program code, for example, a microcontroller, a microprocessor, a CPU, a GPU, an auxiliary processing unit, a FPGA, or the like.

In one embodiment, the method 900 begins and connects 905 to a base station of a mobile wireless communication network. In one embodiment, the method 900 verifies 910 an authenticity of the connected base station while in an inactive state. In one embodiment, the method 900 disconnects 915 from the connected base station in response to the authenticity of the connected base station failing, and the method 900 ends.

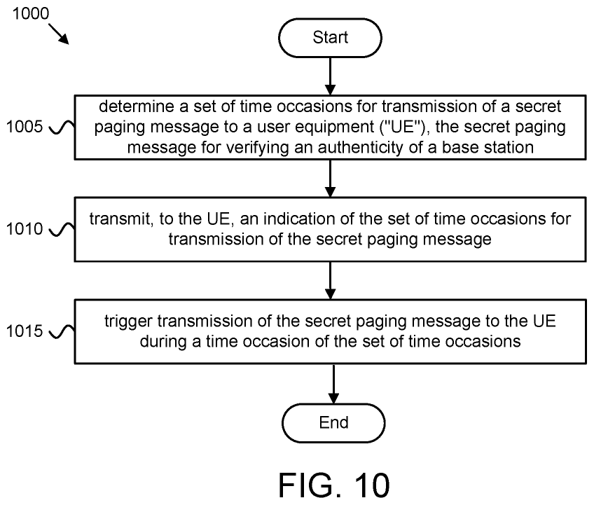

FIG. 10 is a flowchart diagram of a method 1000 for enhancing security against false base stations. The method 1000 may be performed by a network entity as described herein, for example, a network function, a base station, and/or the network equipment apparatus 800. In some embodiments, the method 1000 may be performed by a processor executing program code, for example, a microcontroller, a microprocessor, a CPU, a GPU, an auxiliary processing unit, a FPGA, or the like.

In one embodiment, the method 1000 begins and determines 1005 a set of time occasions for transmission of a secret paging message to a user equipment (“UE”), the secret paging message for verifying an authenticity of a base station. In one embodiment, the method 1000 transmits 1010, to the UE, an indication of the set of time occasions for transmission of the secret paging message. In one embodiment, the method 1000 triggers 1015 transmission of the secret paging message to the UE during a time occasion of the set of time occasions, and the method 1000 ends.

A first apparatus is disclosed for enhancing security against false base stations. The first apparatus may include a UE as described herein, for example, the remote unit 105 and/or the user equipment apparatus 700. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver and a processor that is coupled to the transceiver. In one embodiment, the processor is configured to cause the apparatus to connect to a base station of a mobile wireless communication network, verify an authenticity of the connected base station while in an inactive state, and disconnect from the connected base station in response to the authenticity of the connected base station failing.

In one embodiment, the processor is configured to cause the apparatus to monitor for a secret paging message from the connected base station, during an occasion, to verify the authenticity of the connected base station.

In one embodiment, the processor is configured to cause the apparatus to receive an indication of the occasion in a protected NAS message.

In one embodiment, the processor is configured to cause the apparatus to monitor paging, based on the protected NAS message, at an offset relative to a paging occasion.

In one embodiment, the occasion comprises an absolute time, or a number of discontinuous reception cycles, or some combination thereof.

In one embodiment, the processor is configured to cause the apparatus to cease monitoring for the secret paging message in response to the apparatus being within an area with a threat level that satisfies a threat level threshold.

In one embodiment, the processor is configured to cause the apparatus to receive standard paging messages from the connected base station using the secret paging message.

In one embodiment, the processor is configured to cause the apparatus to receive a secret S-TMSI from a network entity for verifying the authenticity of the connected base station.

In one embodiment, the processor is configured to cause the apparatus to monitor for the secret S-TMSI in paging messages to verify the authenticity of the connected base station.

In one embodiment, the processor is configured to cause the apparatus to receive the secret S-TMSI during a paging occasion of the apparatus's regular paging occasions.

In one embodiment, the processor is configured to cause the apparatus to receive the secret S-TMSI in a protected NAS message at least once within a time window.

In one embodiment, the inactive state is one of an RRC idle state and an RRC inactive state.

A first method is disclosed for enhancing security against false base stations. The first method may be performed by a UE as described herein, for example, the remote unit 105 and/or the user equipment apparatus 700. In some embodiments, the first method may be performed by a processor executing program code, for example, a microcontroller, a microprocessor, a CPU, a GPU, an auxiliary processing unit, a FPGA, or the like.

In one embodiment, the first method connects to a base station of a mobile wireless communication network, verifies an authenticity of the connected base station while in an inactive state, and disconnects from the connected base station in response to the authenticity of the connected base station failing.

In one embodiment, the first method monitors for a secret paging message from the connected base station, during an occasion, to verify the authenticity of the connected base station.

In one embodiment, the first method receives an indication of the occasion in a protected NAS message.

In one embodiment, the first method monitors paging, based on the protected NAS message, at an offset relative to a paging occasion.

In one embodiment, the occasion comprises an absolute time, or a number of discontinuous reception cycles, or some combination thereof.

In one embodiment, the first method ceases monitoring for the secret paging message in response to the apparatus being within an area with a threat level that satisfies a threat level threshold.

In one embodiment, the first method receives standard paging messages from the connected base station using the secret paging message.

In one embodiment, the first method receives a secret S-TMSI from a network entity for verifying the authenticity of the connected base station.

In one embodiment, first method monitors for the secret S-TMSI in paging messages to verify the authenticity of the connected base station.

In one embodiment, the first method receives the secret S-TMSI during a paging occasion of the apparatus's regular paging occasions.

In one embodiment, the first method receives the secret S-TMSI in a protected NAS message at least once within a time window.

In one embodiment, the inactive state is one of an RRC idle state and an RRC inactive state.

A second apparatus is disclosed for enhancing security against false base stations. The second apparatus may include a network entity as described herein, for example, a network function, a base station, and/or the network equipment apparatus 800. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver and a processor that is coupled to the transceiver. In one embodiment, the processor is configured to cause the apparatus to determine a set of time occasions for transmission of a secret paging message to a UE, the secret paging message for verifying an authenticity of a base station, transmit, to the UE, an indication of the set of time occasions for transmission of the secret paging message, and trigger transmission of the secret paging message to the UE during a time occasion of the set of time occasions.

In one embodiment, the processor is configured to cause the apparatus to generate a secret S-TMSI for the UE, the S-TMSI for verifying the authenticity of the base station.

In one embodiment, the processor is configured to cause the apparatus to transmit a secret paging configuration to the UE during a secured session between the apparatus and the UE, the secret paging configuration indicating the set of time occasions, the secret S-TMSI, or both.

A second method is disclosed for enhancing security against false base stations. The second method may be performed by a network entity as described herein, for example, a network function, a base station, and/or the network equipment apparatus 800. In some embodiments, the second method may be performed by a processor executing program code, for example, a microcontroller, a microprocessor, a CPU, a GPU, an auxiliary processing unit, a FPGA, or the like.

In one embodiment, the second method determines a set of time occasions for transmission of a secret paging message to a UE, the secret paging message for verifying an authenticity of a base station, transmits, to the UE, an indication of the set of time occasions for transmission of the secret paging message, and triggers transmission of the secret paging message to the UE during a time occasion of the set of time occasions.

In one embodiment, the second method generates a secret S-TMSI for the UE, the S-TMSI for verifying the authenticity of the base station.

In one embodiment, the second method transmits a secret paging configuration to the UE during a secured session between the apparatus and the UE, the secret paging configuration indicating the set of time occasions, the secret S-TMSI, or both.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a transceiver; and
a processor coupled to the transceiver, the processor configured to cause the apparatus to:
connect to a base station of a mobile wireless communication network;
verify an authenticity of the connected base station while in an inactive state; and
disconnect from the connected base station in response to the authenticity of the connected base station failing.

2. The apparatus of claim 1, wherein the processor is configured to cause the apparatus to monitor for a secret paging message from the connected base station, during an occasion, to verify the authenticity of the connected base station.

3. The apparatus of claim 2, wherein the processor is configured to cause the apparatus to receive an indication of the occasion in a protected non-access stratum (“NAS”) message.

4. The apparatus of claim 3, wherein the processor is configured to cause the apparatus to monitor paging, based on the protected NAS message, at an offset relative to a paging occasion.

5. The apparatus of claim 2, wherein the occasion comprises an absolute time, or a number of discontinuous reception cycles, or some combination thereof.

6. The apparatus of claim 2, wherein the processor is configured to cause the apparatus to cease monitoring for the secret paging message in response to the apparatus being within an area with a threat level that satisfies a threat level threshold.

7. The apparatus of claim 2, wherein the processor is configured to cause the apparatus to receive standard paging messages from the connected base station using the secret paging message.

8. The apparatus of claim 1, wherein the processor is configured to cause the apparatus to receive a secret serving temporary mobile subscriber identity (“S-TMSI”) from a network entity for verifying the authenticity of the connected base station.

9. The apparatus of claim 8, wherein the processor is configured to cause the apparatus to monitor for the secret S-TMSI in paging messages to verify the authenticity of the connected base station.

10. The apparatus of claim 9, wherein the processor is configured to cause the apparatus to receive the secret S-TMSI during a paging occasion of the apparatus's regular paging occasions.

11. The apparatus of claim 8, wherein the processor is configured to cause the apparatus to receive the secret S-TMSI in a protected non-access stratum (“NAS”) message at least once within a time window.

12. The apparatus of claim 1, wherein the inactive state is one of a radio resource control (“RRC”) idle state and an RRC inactive state.

13. A method of a user equipment (“UE”) apparatus, comprising
connecting to a base station of a mobile wireless communication network;
verifying an authenticity of the connected base station while in an inactive state; and
disconnecting from the connected base station in response to the authenticity of the connected base station failing.

14. An apparatus, comprising:
a transceiver; and
a processor coupled to the transceiver, the processor configured to cause the apparatus to:
determine a set of time occasions for transmission of a secret paging message to a user equipment (“UE”), the secret paging message for verifying an authenticity of a base station;
transmit, to the UE, an indication of the set of time occasions for transmission of the secret paging message; and
trigger transmission of the secret paging message to the UE during a time occasion of the set of time occasions.

15. The apparatus of claim 14, wherein the processor is configured to cause the apparatus to generate a secret serving temporary mobile subscriber identity (“S-TMSI”) for the UE. the S-TMSI for verifying the authenticity of the base station.
